(19) United States
(12) Patent Application Publication
(10) Pub. No.: US 2018/0132425 A1
(43) Pub. Date: May 17, 2018

(54) PERPENDICULAR BLADED MANUAL LAWN EDGER

(71) Applicant: ORIN WALTER GROVUM, CALGARY (CA)

(72) Inventor: ORIN WALTER GROVUM, CALGARY (CA)

(21) Appl. No.: 15/349,089

(22) Filed: Nov. 11, 2016

(51) Int. Cl. A01G 3/06

(52) U.S. Cl. CPC A01G 3/06

(57) ABSTRACT

A long handled lawn edging and sod cutting tool, which employs a blade, the length of which protrudes downward from the bottom end of the shaft, and in a straight line from the shaft, and that is sharp on the curved side and tapered to a point and set perpendicular to the narrow bar foot pedals and the handlebars of the tool. The sharp tapered to a point blade enables the user to initially pierce the sod with a small point, then cut as the blade taper widens, and to edge a lawn or cut sod more easily and more quickly than with a conventional or half-moon edger.

### CROSS-REFERENCE TO RELATED APPLICATIONS

“This application claims the benefit of Provisional Patent Application 62/257724 FILED Nov. 20, 2015

### STATEMENT REGARDING PRIOR DISCLOSURE BY THE INVENTOR

The only prior disclosure is the filing of a “Provisional Patent Application”, which was assigned the number 62/257724, on Nov. 20, 2015.

### BACKGROUND OF THE INVENTION

Lawn edgers are of two types, 1) manual, and 2) motor driven. The most common style of manual lawn edger is the “half-moon” type, where the user stands on the sidewalk, facing the lawn, and steps down on one side of the half-moon blade. The half-moon edger is produced by many companies, and can be found amongst the lawn tools of most North American home owners.

The half-moon style of edger is quite laborious and time-consuming to use. It was in contemplation of using a half-moon edger that the inventor came up with the idea that he has since called “MACHEDGER”. The question in the inventor's mind was “what kind of tool could be used to cut through the grass and sod overhanging the sidewalk, which would be easier, and enable the job to be completed in less time?”

The inventor thought of using an old machete, and tried it out. The machete cut through grass and sod very well, but the inventor found himself on his knees to perform the job. His next thought was to lengthen the machete handle, and add foot pedals, to make the tool much easier and faster to use.

A “preliminary search” did not find any lawn edgers with a similar blade or foot pedal design. Most edger patents have half-moon or rectangular blades. U.S. Pat. No. 5,590,720-A (Downing) has the blade perpendicular to the handle bars, however it employs a foot plate, and uses a rounded or bowed blade (similar to a half-moon blade), fastened under the footplate, and is without any sharp tapered point to pierce the sod (even though the blade itself may be sharp). U.S. Pat. No. 4,437,523-A (Isbell) has a round or circular blade, and again no sharp tapered point to pierce the sod. This provides support to the claim that the Invention blade (with a tapered spear-like point) is a new and unique design for manual lawn edger and sod cutters.

### BRIEF SUMMARY OF THE INVENTION

The Invention is a “long-handled lawn tool” with a “blade that is tapered to a point, and set perpendicular to the handles and foot pedals” of the tool. It can be used to trim the grass and sod that overhangs the sidewalk, to trim around flower-beds, and to cut and shape sod, when laying the sod.

The Invention has “handle-bars” at the top of the shaft or handle, and “foot pedals” just above the blade. The handle-bars and foot pedals are parallel to each other, while the blade is perpendicular to both of them. The point tapered to a point blade easily penetrates sod and cuts sod and grass, making the Invention easy to use and a time saver. The Invention is applied “point first” into the sod.

The purpose of this Invention is to make the job of lawn edging less laborious than with a half-moon edger, and to save the user time. This Invention accomplishes both of these objectives.

### BRIEF DESCRIPTION OF DRAWINGS

There are three pages of drawings.

FIG. 1. This view is a frontal cross section, which shows the handlebars at the top, then the shaft, the foot pedals, and the blade at the bottom.

FIG. 2. This view is a side cross section, again showing the handlebars at the top, then the shaft, the foot pedals, and the tapered to a point blade at the bottom.

FIG. 3. This is a top view of the foot pedals, showing the hole that allows them to be slid onto the bottom of the shaft, and welded in place, perpendicular to the blade.

FIG. 4. This view is a cross section of the lower end of the shaft, which shows where the tapered to a point blade is inserted into the end of the shaft, and welded into place.

FIG. 5. This view is of the blade, which is tapered to a sharp point, and fits into the lower end of the shaft, where it is welded into place.

FIG. 6. This view is of the lower part of the Invention, and shows a portion of the shaft, then the blade and foot pedals after they have been welded in place.

FIG. 7. This view is a picture of the whole Invention, after it has been assembled and painted, and with rubber grips on the handlebars.

### DESCRIPTION

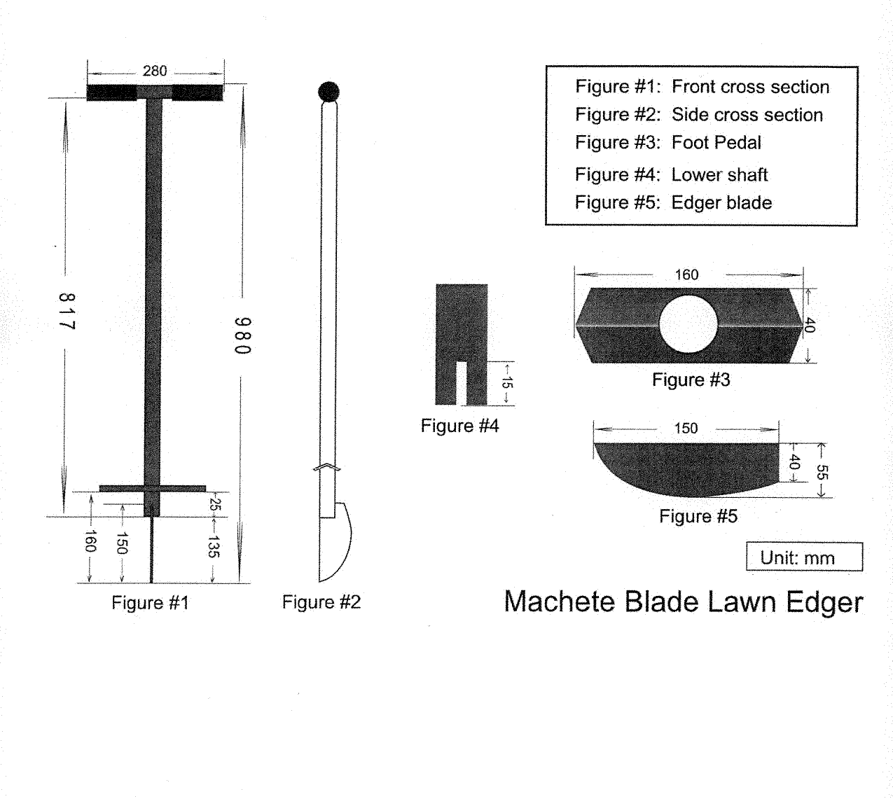

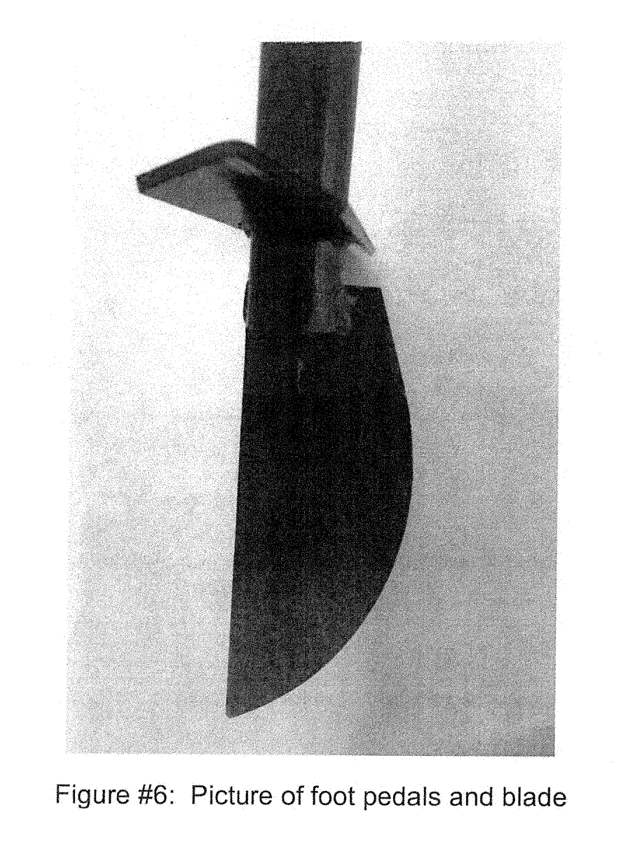

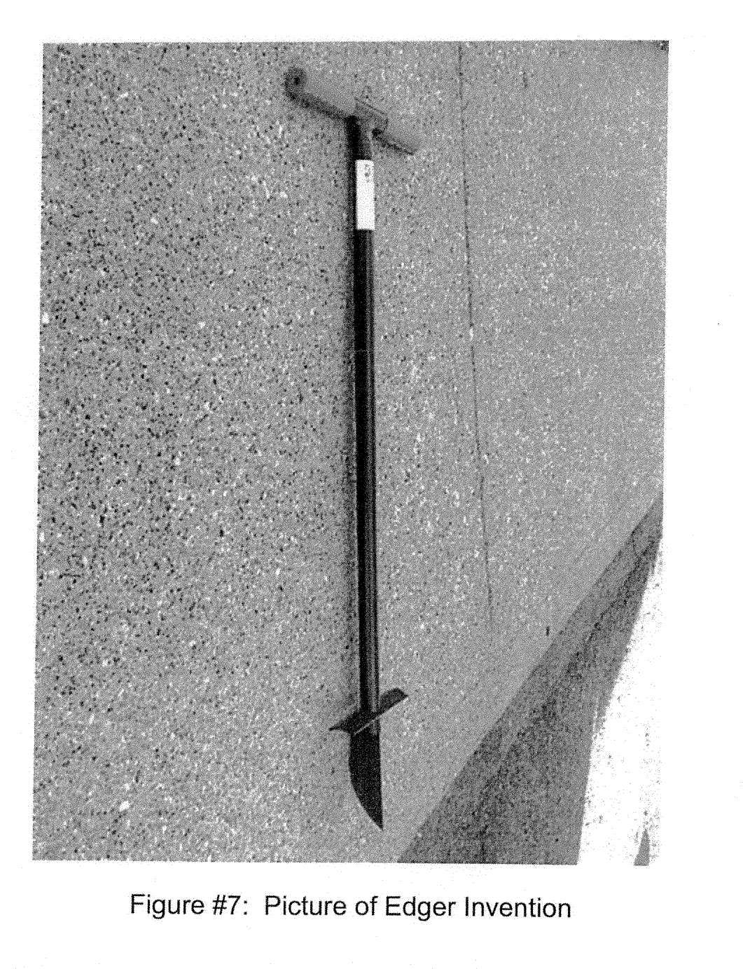

The Invention (approximately 3 feet in length) is comprised of a) a foot pedal (FIG. 3), b) a handle or shaft with handlebars (FIG. 1), and c) a tapered to a point blade (FIG. 5). The foot pedal is an angled bar, made of steel, with a hole in the center, so that it can be slid on to the bottom of the shaft, where it is welded in place, parallel with the handlebars, and just above the slot (FIG. 4) that the blade fits into. The tapered to a point blade is quite thin, and has a point that easily penetrates sod. One side of the blade protrudes straight from the bottom of the shaft, and the other side which is curved from the point back to the shaft, is sharp, and cuts sod as the taper of the blade widens. The blade is welded into the slot at the bottom of the handle, or shaft (FIG. 2 and FIG. 6—which is a picture of the blade and foot pedals), perpendicular to the handlebars and foot pedals.

The key and unique feature of the Invention, is its sharp tapered to a point blade, the point of which easily pierces sod. When assembled, the invention can be inserted into the sod that has begun to overhang the sidewalk, with moderate foot pressure on the foot pedals, and using the sidewalk as a guide, employed with short pumping motions, always moving backwards, to take advantage of the angle of the blade. Because of the sharpness of the blade, and its penetrating point, the user can work quickly and greatly improve on the time required to do the same job as with a conventional or half-moon edger. The user moves backwards along the sidewalk (or other surface that limits the spread of the grass), usually with one foot on the sidewalk and the other pumping the Invention foot pedals, or alternately, one foot on the grass and the other foot pumping the foot pedals. FIG. 6 is a picture of the lower section of the Invention, specifically showing the foot pedals and the tapered to a point blade.

Ease of use, and getting the job done quickly, were the motivating factors that have produced this Invention. Using it instead of a conventional or half-moon edgers can cut the users edging time by more than half. The length of the shaft enables most users to stand relatively straight while employing it. A demonstration of using the Invention can be seen at https://youtu.be/8zM2bhn9KI0 .

The embodiments of the invention in which an exclusive property or privilege is claimed are set out below as follows:

1. (canceled)

2. (canceled)

3. (canceled)

4. A long handled lawn tool comprising:
a tapered to a point blade, which is neither arcuate nor in the shape of a bow, but rather extends straight down from a shaft or handle, the end of which is a point, on one side, and is tapered in a curve from the tip or point of the blade on the other side of the blade, back up to the opposite side of the shaft, where the blade has a narrow end (width), which narrow end is approximately one quarter of the length of the blade, and which is welded to the bottom of the shaft in such a way that when the tool is held by the handle bars, the tapered point of the blade will make first contact with the ground, and which curved side of the blade is sharpened or serrated for improved cutting,
a foot pedal in the form of a narrow angled bar, which is attached to the shaft near the blade at the bottom end of the shaft, and that protrudes an equal distance on both sides of the shaft enabling the user to step down on the tool with either the left or right foot, and which foot pedal is fastened perpendicular to the orientation of the sharp, tapered to a point blade,
a shaft or handle, that is longer than the foot pedals and/or handle bars, and to which the handle bars are attached at the top end, and to which the blade is attached at its bottom end, and to which the foot pedals are attached just above the blade,
handle bars that are wide enough to enable the user to hold the tool with both hands, which handle bars are fastened to the top of the shaft or handle of the tool, parallel to the foot pedals and in such a way that an equal portion of the handle bars protrude on each side of the shaft or handle,
the tapered to a sharp point blade of this tool, which easily pierces sod and grass, and which has a tapered curved side which side is sharpened, easily cuts as it is stepped into the sod by virtue of the widening taper of the blade, and that this tapered to a point blade, when employed, this tapered blade point first pierces the sod, and is new and unique to turf trimmers, lawn edgers and sod cutters.

5. The apparatus of claim 4, wherein the foot pedals protrude as narrow angled bars on both sides near the bottom end of the shaft, and are perpendicular to the blade.
